(19) United States
(12) Patent Application Publication
(10) Pub. No.: US 2023/0286035 A1
(43) Pub. Date: Sep. 14, 2023

(54) METHOD AND SYSTEM FOR AUTOMATED WAX MOLD ASSEMBLY

(71) Applicant: Canon Virginia, Inc., Newport News, VA (US)

(72) Inventors: David M. Rumery, Newport News, VA (US); Henry L. Schuman, Newport News, VA (US); Wiliam J. Salerno, Williamsburg, VA (US); Steve Titus, Newport News, VA (US); Jason Siebert, Williamsburg, VA (US)

(21) Appl. No.: 18/013,526

(22) PCT Filed: Jun. 30, 2021
(86) PCT No.: PCT/US2021/039933

§ 371 Date: Dec. 28, 2022

Related U.S. Application Data
(60) Provisional application No. 63/046,423, filed on Jun. 30, 2020.
(60) Provisional application No. 63/046,534, filed on Jun. 30, 2020.
(60) Provisional application No. 63/046,486, filed on Jun. 30, 2020.

(51) Int. Cl. B22C 7/02; B22C 9/04; B25J 9/00; B25J 13/08; B25J 19/02; B25J 11/00

(52) U.S. Cl. CPC B22C 7/026; B22C 9/04; B25J 9/0018; B25J 9/0084; B25J 11/005; B25J 13/085; B25J 19/022

(57) ABSTRACT

The present disclosure relates to methods and systems for automating the assembly method for building a wax mold, including a force/torque sensor attached to a robotic arm that provides feedback to a robot controller to determine when to stop motion of the robotic arm, and using a visible spectrum laser to accurately measure translucent wax and plastic parts for orientation, processing, assembly and inspection of assembled products.

### PRIORITY AND INCORPORATION BY REFERENCE

The present application claims priority to U.S. Provisional Pat. Application Serial Nos. 63/046,423, 63/046,534 and 63/046,486, each of which was filed Jun. 30, 2020, and the disclosure of each of which is incorporated herein by reference in their entirety.

### TECHNICAL FIELD

The present disclosure relates to methods and devices for use in the automated assembly and/or preparation of wax molds usable in lost wax casting.

### BACKGROUND

The casting of metal objects using a lost wax process is an ancient and well-known process that is still widely used in areas including the manufacture of jewelry, dentistry, the arts, and industry. When used for industry, lost wax casting may also be referred to as investment casting, and is commonly used in engineering and manufacturing applications to create precision metal parts.

Traditionally, lost wax casting is a manual process; the wax molds are assembled by hand, which is a labor-intensive, time-consuming operation and allows for a high degree of variation in part placement. An operator would gather all of the necessary parts and then start the assembly process. Using templates, hot irons, melted wax and other methods they would assemble the molds’ multiple parts following the work standards for the specific wax mold. During the assembly process, an operator would have to place each part in its specific location, customizing multiple parts to fit by trimming and melting to size, then placing them in the desired location.

To verify that each part on the wax mold meets the finished product’s quality requirement the wax mold is then transferred to an inspection station. At the inspection station, the operator manually verifies each part and its supporting structures position by sliding a template over each part/structure one at a time, rotating the wax mold’s assembly to verify each location.

The steps in lost wax casting include those found in FIG. 1, namely wax injection, pattern assembly, shell making, de-waxing, metal pouring, and shell removal, resulting in a finished product. In this process a wax mold is dipped in a ceramic slurry which hardens to form a ceramic shell (shell making). The wax mold is constructed by assembling wax parts in the form of a weldment. These parts are created through injection molding, 3d printing, or other (usually additive) manufacturing methods. These solid wax parts are welded (fused) together by hand using a hot iron, molten liquid wax, or a combination of both.

The shell is then heated and wax is removed (de-waxing). The next step in the process is normally metal pouring, but it sometimes is necessary to perform additional preparation of the shell prior to metal pouring (shell prep), which can include the intentional fracturing and removal of portions of the ceramic shell.

Attempts to automate this process requires precise accuracy of its component parts and each step of the process, including placement and welding of the mold parts, as well as measurements and inspection of the mold.

The process of manually assembling a completed wax mold, one part at a time, using hand tools to melt and assemble wax parts allows for a high degree of variation in the parts location. Manual assembly leads to increased rework on the final product due to it not passing the quality inspection requirements. Variations in operator methods, assembly times, temperatures, parts, etc. can all influence the quality and reliability of the finished assembled mold.

Manually measuring these parts defeats the purpose of saving labor by automation. Some parts are very difficult to precisely measure sufficiently to allow automated assembly. For translucent wax and plastic materials, identification of the exact edge has been difficult for most light and laser based measurement devices. Using a visible spectrum laser proved capable to provide the data in a digital format to allow automated assembly, processing and inspection of the materials.

Automation can include the use of robot applications. A robotic application requires pre-programed destination positions or teach points that are stored in the robot controller and the robot moves to them in a user defined sequence. These sequences can be used to create any number of process in which a robot manipulates a work piece, for instance, a wax mold. When manipulating work pieces that have inconsistent geometry a difference can occur in the pre-programed position and the actual part position.

When the difference in the pre-programed position and the actual part position occurs the programmer must re-program the teach point so that it matches the new part position. This can occur multiple times throughout a run creating significant down time and potential for a robot crash or mispick.

### SUMMARY OF THE DISCLOSURE

According to aspects of the present disclosure, there is provided in a first aspect a method and system for automating the assembly method for building a wax mold. The automation uses multiple inverted 6-axis robots to pick parts from their defined location(s). The automated assembly cell uses a laser displacement system to measure the main sub-assemblies location and adjusts its position by use of custom software.

According to aspects of the present disclosure, there is provided a method and system for using a visible spectrum laser to accurately measure translucent wax and plastic parts for orientation, processing, assembly and inspection of assembled products. In another aspect it converts the actual measurement data to code. An algorithm compares the actual dimensions to the original model and identifies the differences from the nominal model. This data is fed back to the processor of the automated assembly cell.

According to aspects of the present disclosure, there is also provided a force/torque sensor attached to a robotic arm that provides feedback to a robot controller. After the robot achieves its final pre-programed position, the controller calls the “Seek Force” algorithm, which allows the robot to continue motion in a user defined vector. While moving in said vector the robot controller monitors the force/torque sensor and will continue motion until force or torque is achieved in a user defined axis and magnitude.

In a further aspect of the disclosure, the automated assembly cell adjusts the processing parameters of the component parts in order to prepare for adjustment to the actual component operations for the purpose of creating an ideal final product assembly. The process parameters for these may include cutting component parts to the proper size and angle, dip coating or spray coating parts to exact tolerances, gluing, melting or otherwise attaching two or more parts together or gluing, melting or otherwise attaching parts to fixtures, jigs, plates or holders. An additional aspect of the disclosure is automatically orienting the component parts or subassemblies to the final product assembly; using the inspection data above, the automated assembly cell can ideally locate the component parts and subassemblies in a way that will match the desired model as closely as possible.

Another aspect of the disclosure is to use a visible spectrum laser to measure the final assembly dimensions, and or interim dimensions and identify orientation or location. The automated assembly cell moves the product and/or laser to measure the dimensions, orientations and final characteristics of the final product. The digital output of the laser for dimensions can be saved electronically and combined with serialization to keep a complete digital history of the product from the component parts to the assembly as well as other downstream processes as required by several regulated industries. Another aspect can be to compare the final digital dimensions to the master model to overlay differences between the two for evaluation.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

FIG. 1 depicts a process diagram of the investment casting (lost wax) process.

FIG. 2 depicts an exemplary automated assembly cell for automation of the process for building a wax mold.

FIG. 3 depicts a force torque sensor that is mounted between the robot flange and robot End of Arm Tooling.

FIG. 4 depicts portion of the system components including a robot arm, robot controller and programmable logic controller (PLC).

FIG. 5 is a flow chart depicting a graphical interpretation of the algorithm that determines when to stop robot motion.

FIG. 6 depicts an example of how a final pre-programed position can be manipulated by the “Seek Force” algorithm.

FIG. 7 depicts an example of how a final pre-programed position can be manipulated by the “Seek Force” algorithm on a robot.

FIG. 8 depicts an example of a component part made from a translucent plastic or wax material.

FIG. 9 depicts the visible spectrum laser measuring the dimensions of the component part.

FIG. 10 depicts the comparison of the actual component measurement to the nominal model of the component.

FIG. 11 depicts automated cutting of an accessory part to represent several types of processing that can be done with automated equipment.

FIG. 12 depicts automated reorientation of the component part.

FIG. 13 depicts automated assembly of the accessory parts to the component part.

FIG. 14 depicts assembly of the component part subassembly to the final product fixture.

FIG. 15 depicts the automated inspection of the final product using a visible spectrum laser.

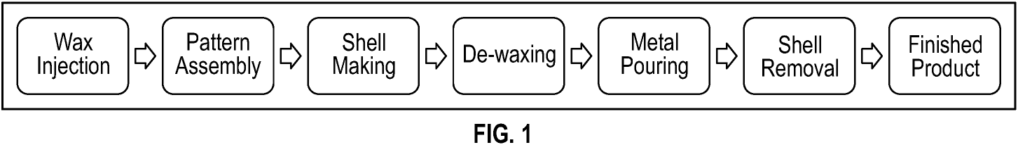

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENT

Exemplary embodiment(s) of the present disclosure will be described in detail below with reference to the accompanying drawings. It is to be noted that the following exemplary embodiment(s) are merely examples for implementing the present disclosure and can be appropriately modified or changed depending on individual constructions and various conditions of apparatuses to which the present disclosure is applied. Thus, the present disclosure is in no way limited to the following exemplary embodiment(s).

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

Therefore, in one embodiment there is provided a system for automated wax mold assembly comprising an assembly cell frame; a base plate; one or more robots moveable with respect to the assembly cell frame, wherein the one or more robots comprise a robotic arm; wherein the one or more robots are in communication with a robot controller; a laser measurement and/or displacement system, end of arm tooling means for movement of mold pieces; end of arm tooling means for cutting and/or welding mold pieces; and an automation system configured to direct the placement, fitting, cutting, and/or welding of mold pieces into a completed mold.

In certain embodiments, the robots are inverted 6-axis robots. A force/torque sensor can provided on one or more of the robots, wherein the force-torque sensor is configured to detect a force or torque applied to a distal (tooling) end of the robotic arm. In certain configurations, the force-torque sensor can be in communication with a robot controller, which in turn can be in communication with a programmable logic controller (PLC).

In other embodiments, there is also provided a method for automated wax mold assembly comprising providing an assembly frame having one or more robots moveable with respect to the assembly frame, a base plate and a laser displacement system; configuring the one or more robots to select one or more mold parts from defined locations; assembling the one or more mold parts on the base plate; wherein assembling comprises one or more of placing, fitting, cutting, and/or welding of the one or more mold pieces; measuring the finished mold with the laser system; and, determining whether the finished mold meets predefined criteria. In certain embodiments, the method can also comprises measuring and/or determining the location of the one or more mold parts with the laser system. In some embodiments, the one or more robots comprise end of arm tooling means for movement of mold pieces and/or end of arm tooling means for cutting and/or welding or attaching mold pieces.

In further embodiments, wherein the method additionally comprises providing a force/torque sensor attached to at least one of the one ore more robots; configuring a robotic controller to cause the robot to perform a pre-set series of movements; wherein, when the robot reaches a pre-determined final position, causing the robotic controller to read force/torque data from the sensor, and causing the robot to continue motion toward a user provided vector if force/torque data does not meet pre-determined conditions.

Another exemplary embodiment provides a method of controlling movement of a robot, comprising providing a robot having a force/torque sensor attached thereto; configuring a robotic controller to cause the robot to perform a pre-set series of movements; wherein, when the robot reaches a pre-determined final position, causing the robotic controller to read force/torque data from the sensor, and causing the robot to continue motion toward a user provided vector if force/torque data does not meet pre-determined conditions.

Further provided is a system for controlled movement of a robot, comprising: a robot; a force/torque sensor; a robotic controller; and a programmable logic controller (PLC), wherein the force/torque sensor is attached to the robot, and sensor communicates force/torque data to the robotic controller and/or the PLC.

In other embodiments, there is provided a process for determining the accuracy of translucent wax or plastic materials, comprising using a visible spectrum length laser to measure component parts made from translucent wax or plastic materials; and comparing the measurements to a desired model of the component parts to determine any variances from the model. The visible spectrum length laser can have a wavelength of from about 400 to 700 nm. In certain embodiments, the visible spectrum length laser can obtain measurements and/or position information using any of the available techniques, including but not limited to triangulation, time of flight measurements, phase shift method, frequency modulation methods and interferometers.

In some embodiments, following the measurement of the component parts, the parts are automatically cut to size, shape and angle. In certain embodiments, the component parts are automatically machined to size, shape, angle or surface finish. In further embodiments, the component parts are automatically assembled to 2 or more other component parts to make a subassembly. The component parts, subassembly and/or completed mold (product) can be automatically precision coated with dip or spray processes. In other embodiments, the component parts and/or subassemblies are automatically glued, melted or otherwise adhered to a fixture, jig, plate or holder.

In further embodiments, there is provided an additional process step of determining the position of the component parts, comparing the detected orientation to a pre-determined desired orientation, and automatically re-orientating the component parts for alignment to attach to the final product assembly. Such processes can be performed using automated equipment, for example, an automated assembly cell according to the present disclosure.

It is also an embodiment of the present disclosure that to facilitate measurement and/or location determination of the components or products, that either the laser or product positions are automatically moved for inspection purposes. Such data provided by the laser measurement/displacement system related to the final product dimensions and orientations can be compared to the master model. In further embodiments, the data of the final product dimensions and orientations are stored digitally allowing for serialization of the final product(s).

Other embodiments provide a system comprising a visible spectrum length laser to measure component parts made from translucent wax or plastic materials to compare to a desired model for processing as described herein, wherein the system comprises automated equipment such as an automated assembly cell according to the present disclosure.

Such embodiments will now be further described with reference to the figures.

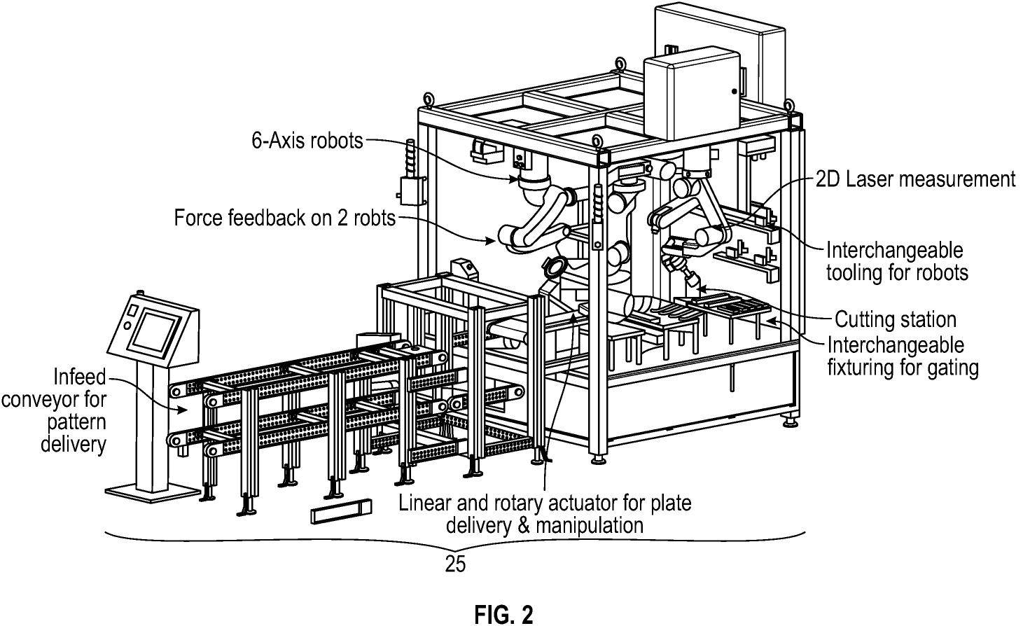

The present disclosure relates to a method and system for automating the assembly method for building a wax mold. In one exemplary embodiment, the system includes an automated assembly cell 25, wherein the automation uses multiple inverted 6-axis robots 12 to pick parts from their defined location(s) in or around an automated assembly cell 25 as shown in FIG. 2. In some embodiments, the robots 12 used in the automated assembly cell 25 can be of other types and configurations, as one of skill in the art would recognize as applicable for the desired automated assembly cell 25. 1, 2 or more of the robots 12 are provided with a force feedback mechanism to assist in the control of the robot. The automated assembly cell 25 additionally comprises a laser measurement (alternatively or in addition displacement and/or location) system 16 to determine the location of the main sub-assemblies used in building the mold, and to adjust its position by use of custom software. With the use of this custom software, the automation determines where to place the main sub-assembly on the assembly base and how to cut the additional mold parts to fit into the assembly correctly. The assembly cell uses custom end of arm tooling (EOAT) 17 at the end of each robot 12 arm to pick each part up and if necessary, present it to a custom cutter 18 so that the part can be cut to the needed length and angle. The EOAT 17 is interchangeable as required for the desired processes necessary to build a desired mold. The automated assembly cell 25 can utilize a wax melting process and device to automatically bond the multiple parts by applying heat and melting the parts into the sub-assembly to form the finished mold. Each assembled mold unit consists of multiple parts attached to the base plate by the use of the other robots operating in conjunction to perform the necessary welding operations. In certain embodiments, plates are delivered to the assembly cell and manipulated via linear and rotary actuators 15. Patterns for the mold can also be delivered to the assembly cell via an infeed conveyor. Furthermore, in another embodiment, there is provided interchangeable fixturing for gating 24.

After the mold assembly is complete, the laser measurement system 16 again measures the main sub-assembly, verifies the part location, and identifies the mold as being completed and conforming to the desired specifications.

By automating the wax mold assembly process, the finished product can be placed in a designated location and the process is then repeatable. Through the automation, each part on each mold is capable of achieving a more repeatable position and form, increasing the quality of the finished product. The use of the automated system additionally provides for completing the assembly of a mold faster than when the mold is prepared via a manual process.

Certain non-limiting features of the present disclosure therefore include the automated assembly of a wax mold using an assembly cell as provided in the present disclosure. Such assembly cell can include the use of inverted 6-axis robots 12 and custom software to direct the motion of the robots 12. The system and method of assembly additionally include part manipulation as a result of laser measurements to ensure fit, reduced cycle time by improved efficiency of assembly, and improved quality by reduced variation in the assembly method.

In one embodiment of the present disclosure, a force/torque sensor can be attached to one or more robotic arms within the assembly cell to provide feedback to a robot controller. After the robot achieves its final pre-programed position, the controller calls the “Seek Force” algorithm, which allows the robot to continue motion in a user defined vector. While moving in said vector the robot controller monitors the force/torque sensor and will continue motion until force or torque is achieved in a user defined axis and magnitude.

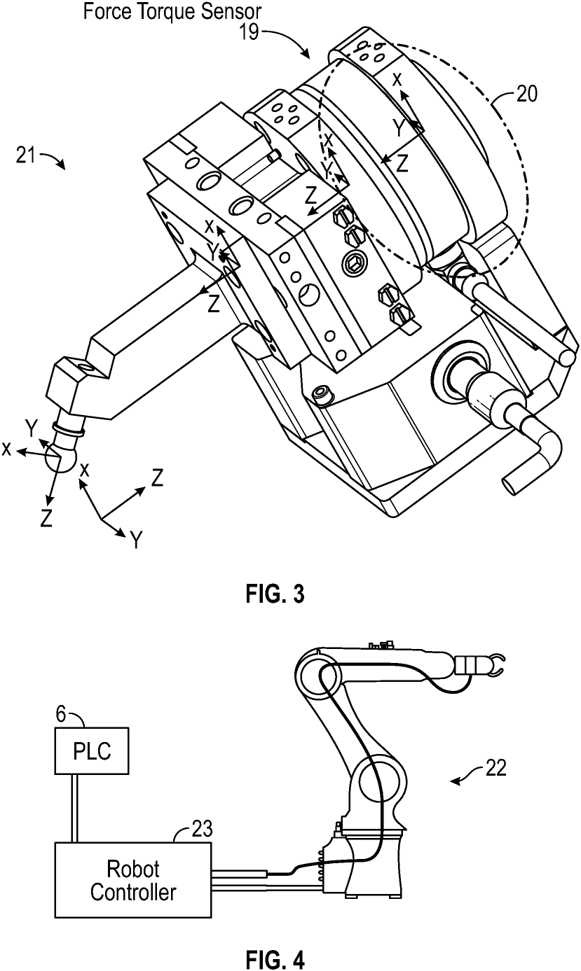

As shown in FIG. 3, a force torque sensor 19 is mounted between the robot flange 20 and robot EOAT 21. This positioning allows for the sensor 19 to detect any forces or torques that maybe exerted on the EOAT 21. The sensor 19 communicates to the robot controller 23 which then communicates to a Programmable Logic Controller (PLC) 6, as shown in FIG. 4.

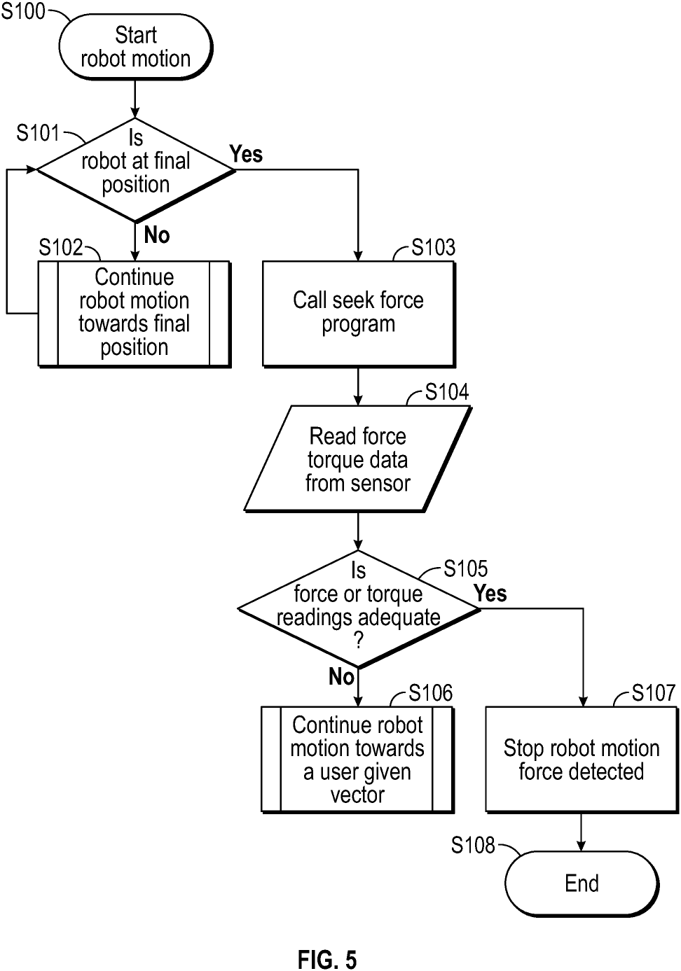

In one exemplary embodiment, the flow chart of FIG. 5 provides a graphical interpretation of how the algorithm “Seek Force” algorithm determines when to stop robot motion. In step S100, the robot motion is started. Step S101 determines whether the robot is at its final programmed position. If no, S102 continues the robot’s motion towards its final position, before repeating S101. If yes, the “Seek Force” algorithm or program is called in S103. S104 reads the force torque data from the sensor 19. S105 determines whether the force or torque reading is adequate for the desired operation. If no, S106 continues the robot’s motion towards a vector defined by the user, before repeating reading the sensor data is S104. If yes, the robot motion is stopped in S107 as the appropriate or adequate force has been detected, and the algorithm or program is stopped in S108.

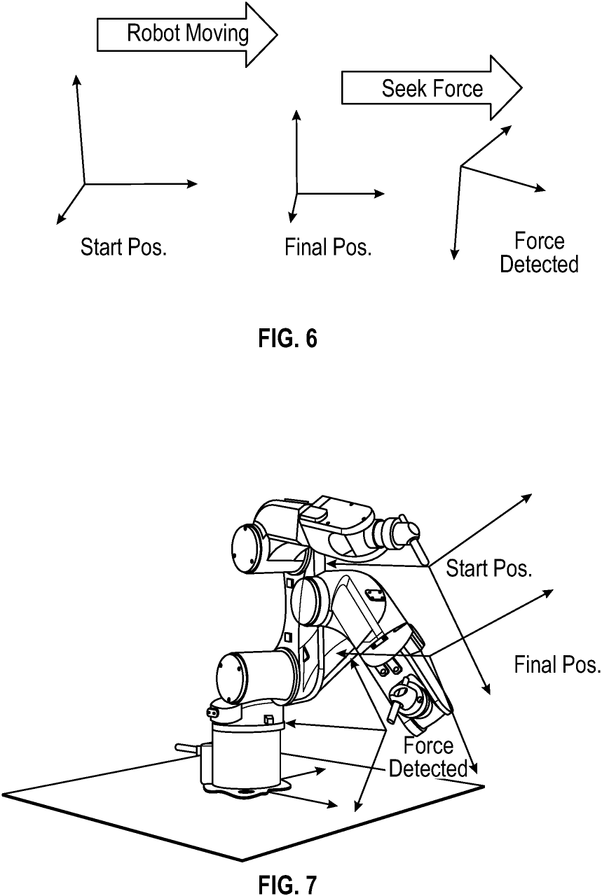

FIG. 6 provides a visual example of how a final pre-programed position can be further manipulated by the “Seek Force” algorithm according to FIG. 5. As depicted in FIG. 6, a robot moves from the initial start position to the final position according to the programmed instructions. Once at the final position, the Force Seek program is started, and after completing steps S100 through S107, the robot has arrived at the position which results in the desired force and/or torque reading. FIG. 7 shows an exemplary illustration of how this process can look on a robot. As seen in FIG. 7, the robot EOAT initially starts at the position indicated by the top most vector. Completion of the programmed movement would have the EOAT 21 positioned at the middle vector, with the requisite force detected by the force torque sensor 19 once the EOAT 21 had reached the position of the bottom vector.

Thus, according to exemplary embodiment, advantages of the present disclosure include a more robust system for handling inconsistent part geometries or final pre-programed positions for the robots 12. The present disclosure can also make teaching these positions easier in applications where the robot EOAT must come in contact or “touch” an inconsistent part, including through AI, neural nets, machine learning and the like. The user can simply teach the system the position near the object that the robot 12 must “touch” and input the vector and desired force/torque magnitude to the “Seek Force” algorithm. In this manner, the force/torque sensor 19 mounted to a robot flange 20 is able to manipulate a pre-programed robot position using feedback from said sensor 19.

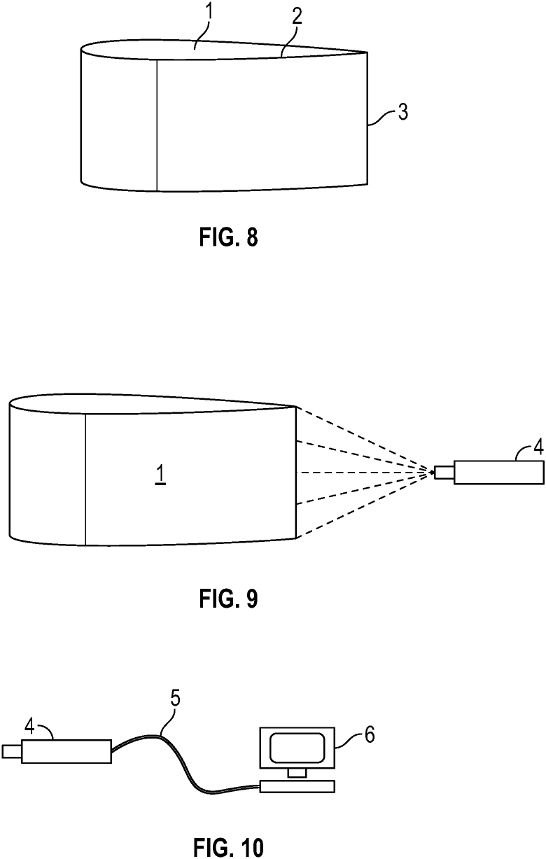

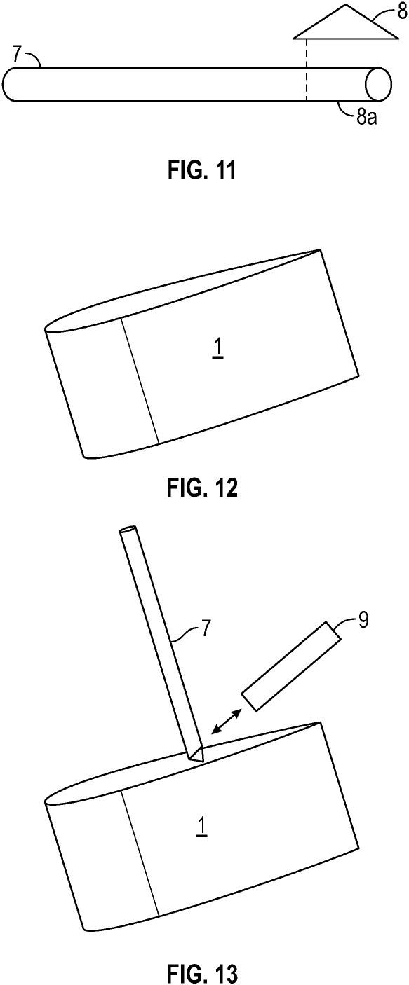

According to other exemplary embodiments, the automated assembly cell 25 can utilize a visible laser system to measure and obtain position information for various components used in the molding process. Component part 1 in FIG. 8 is a molded wax or plastic part which has dimensional variation inherit with the molding processes. Datum features can be added to either the component part or critical surfaces; for example critical surfaces 2 and 3 can be used as datum to characterize the component part 1. Component part 1 is held by the system in a manner so as to not obstruct the datum features of component part 1, allowing component part 1 to be accessed by the laser measurement/positioning system. The automated assembly cell 25 moves component part 1 and/or the visible spectrum laser 4 to measure the datum features 2 and 3 as shown in FIG. 9. Once visible spectrum laser 4 absolutely measures the actual dimensions and/or position of component part 1, the laser 4 communicates the dimension data via cable 5, for example an ethernet cable or other suitable communication protocol, to automation programmable logic controller (PLC) 6, as shown in FIG. 10. In one exemplary embodiment, the PLC 6 compares the actual dimensions to a 3-dimensional model and calculates required offsets for ensuing operations in the molding process. For instance, based on component part 1′s actual dimensions, the PLC 6 calculates adjustments required to accessory part 7 to make the final product as close to the desired model as possible. In this example depicted in FIG. 11, accessory part 7 is cut by a blade 8 (along the dotted cut line 8a) to the proper length and angle as controlled by the automated assembly cell 25 and the robots 12 having the appropriate EOAT 21. Similarly, using information obtained by the laser measurement/positioning systems, the assembly cell can perform other operations on the component part 1 or accessory part 7 or to additional parts of the molding process, including machining the parts, coating parts via dip or spray methods, proper holding of the component part 1 or accessory part 7 or similar by jigs and fixtures. Furthermore, laser measurement/position determinations can be obtained for other accessory or additional parts. In one embodiment, based on the measurement/position information obtained from laser 4 and communicated to PLC 6, FIG. 12 shows that component part 1 has been reoriented from the original position in FIG. 8 to a desired position as calculated by the PLC 6. It should be noted that in FIG. 8 et sec, the holder for component part 1 is not shown.

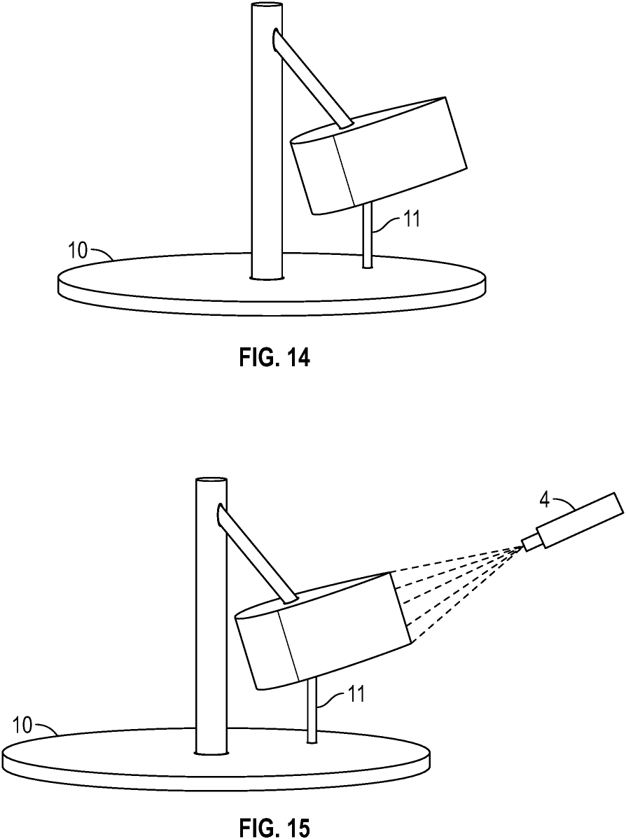

In a further embodiment, FIG. 13 depicts the attachment of accessory part 7 (previously cut in FIG. 11) to component part 1 by the assembly cell. Methods of attachment or fixation 9 include welding by contact with hot iron, laser welding, or gluing by adhesive, solvent or melted wax/plastic as long as the attachment is performed by the assembly cell 25 (and in particular the robot(s) 12 having EOAT 21) using the data from the visible spectrum laser 4 to optimize the final product dimensions and orientation. FIG. 14 depicts automatic assembly of a component part or component part subassembly to a final product. This can be a final wax or plastic assembly but the component parts can be assembled to a jig or fixture 10. In some embodiments, additional parts 11 are used for structural soundness but those additional parts 11 must be measured by the visible spectrum laser 4 and the data utilized by the PLC 6 to ensure proper location of the final product. Methods of attachment 9 to the jig or fixture 10 include welding by contact with hot iron, laser welding, or gluing by adhesive, solvent or melted wax/plastic as long as the attachment is performed by the assembly cell 25 using the data from the visible spectrum laser 4 to optimize the final product dimensions and orientation. Once the final product is assembled, the visible spectrum laser 4 is moved by the assembly cell 25 to perform final location and orientation measurements using the product datum as depicted in FIG. 15. As depicted in FIG. 10, the data from the visible spectrum laser 4 is communicated via cable 5, for example an ethernet cable or other appropriate communication protocol, to the automation programmable logic controller (PLC) 6. The PLC 6 compares the actual dimensions to the desired 3-dimensional model. This data can be serialized and transferred to ensuing processing steps as required by several industries.

Embodiment(s) of the present disclosure, including but not limited to, programming of the desired robot movements, changing of EOAT, assembly methods, desired final product configurations, the “Seek Force” algorithm, and laser measurement and positioning determination, can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. An I/O interface can be used to provide communication interfaces to input and output devices, which may include a keyboard, a display, a mouse, a touch screen, touchless interface (e.g., a gesture recognition device) a printing device, a light pen, an optical storage device, a scanner, a microphone, a camera, a drive, communication cable and a network (either wired or wireless).

The detector interface also provides communication interfaces to input and output devices. The detector may include, for example a photomultiplier tube (PMT), a photodiode, an avalanche photodiode detector (APD), a charge-coupled device (CCD), multipixel photon counters (MPPC), or other. Also, the function of detector may be realized by computer executable instructions (e.g., one or more programs) recorded on a Storage/RAM.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature’s relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A system for automated wax mold assembly comprising:
an assembly cell frame;
a base plate;
one or more robots moveable with respect to the assembly cell frame, wherein the one or more robots comprise a robotic arm; wherein the one or more robots are in communication with a robot controller;
a laser measurement and/or displacement system,
end of arm tooling means for movement of mold pieces;
end of arm tooling means for cutting and/or welding mold pieces; and
an automation system configured to direct the placement, fitting, cutting, and/or welding of mold pieces into a completed mold.

2. The system of claim 1, wherein the robots are inverted 6-axis robots.

3. The system of claim 1, wherein the force/torque sensor is provided on one or more of the robots.

4. The system of claim 3, wherein the force-torque sensor is configured to detect a force or torque applied to a distal end of the robotic arm.

5. The system of claim 4, wherein the force-torque sensor is in communication with the robot controller.

6. The system of claim 5, wherein the robot controller is in communication with a programmable logic controller (PLC).

7. A method for automated wax mold assembly comprising:
providing an assembly frame having one or more robots moveable with respect to the assembly frame, a base plate and a laser displacement system;
configuring the one or more robots to select one or more mold parts from defined locations;
assembling the one or more mold parts on the base plate; wherein assembling comprises one or more of placing, fitting, cutting, and/or welding of the one or more mold pieces;
measuring the finished mold with the laser system; and,
determining whether the finished mold meets pre-defined criteria.

8. The method of claim 7, wherein the one or more robots comprise end of arm tooling means for movement of mold pieces and/or end of arm tooling means for cutting and/or welding mold pieces.

9. The method of claim 7, wherein the method additionally comprises measuring and/or determining the location of the one or more mold parts with the laser system.

10. The method of claim 7, wherein the method additionally comprises:
providing a force/torque sensor attached to at least one of the one ore more robots;
configuring a robotic controller to cause the robot to perform a pre-set series of movements;
wherein, when the robot reaches a pre-determined final position, causing the robotic controller to read force/torque data from the sensor, and causing the robot to continue motion toward a user provided vector if force/torque data does not meet pre-determined conditions.

11. A method of controlling movement of a robot, comprising:
providing a robot having a force/torque sensor attached thereto;
configuring a robotic controller to cause the robot to perform a pre-set series of movements;
wherein, when the robot reaches a pre-determined final position, causing the robotic controller to read force/torque data from the sensor, and causing the robot to continue motion toward a user provided vector if force/torque data does not meet pre-determined conditions.

12. A system for controlled movement of a robot, comprising:
a robot;
a force/torque sensor;
a robotic controller; and
a programmable logic controller (PLC),
wherein the force/torque sensor is attached to the robot, and sensor communicates force/torque data to the robotic controller and/or the PLC.

13. A process for determining the accuracy of translucent wax or plastic materials, comprising:
using a visible spectrum length laser to measure component parts made from translucent wax or plastic materials; and
comparing the measurements to a desired model of the component parts to determine any variances from the model.

14. The process of claim 13 where component parts are automatically cut to size, shape and angle.

15. The process of claim 13 where component parts are automatically machined to size, shape, angle or surface finish.

16. The process of claim 13 where component parts are automatically assembled to 2 or more other component parts to make a subassembly.

17. The process of claim 13 where component parts are automatically precision coated with dip or spray processes.

18. The process of claim 13 where component parts are automatically glued, melted or otherwise adhered to a fixture, jig, plate or holder.

19. The process of claim 13 additionally comprising determining the position of the component parts, comparing the detected orientation to a pre-determined desired orientation, and automatically re-orientating the component parts for alignment to attach to the final product assembly.

20. The process of claim 13, wherein the process is performed using automated equipment.

21. The process of claim 19 where the laser or product positions are automatically moved for inspection purposes.

22. The process of claim 21 where the data of the final product dimensions and orientations are compared to the master model.

23. The process of claim 22 where the data of the final product dimensions and orientations are stored digitally allowing for serialization of the final product(s).

24. A system comprising a visible spectrum length laser to measure component parts made from translucent wax or plastic materials to compare to the model for processing using automated equipment.
